(19) United States
(12) Patent Application Publication
(10) Pub. No.: US 2014/0076797 A1
(43) Pub. Date: Mar. 20, 2014

(54) FIBER-BASED FILTER WITH NANONET LAYER AND PREPARATION METHOD THEREOF

(71) Applicant: KOREA INSTITUTE OF SCIENCE AND TECHNOLOGY, Seoul (KR)

(72) Inventors: Seong-Mu JO, Seoul (KR); Dong-Young KIM, Seoul (KR)

(73) Assignee: KOREA INSTITUTE OF SCIENCE AND TECHNOLOGY, Seoul (KR)

(21) Appl. No.: 13/764,068

(22) Filed: Feb. 11, 2013

(30) Foreign Application Priority Data
Sep. 20, 2012 (KR) 10-2012-0104542

(51) Int. Cl. B01D 39/16

(52) U.S. Cl. CPC B01D 39/1623
USPC 210/505; 427/244

(57) ABSTRACT

A fiber-based filter includes a filter-based porous body having a most frequent pore size from 0.1 μm to 2 μm in a pore size distribution, in which a ultra-fine fiber is continuously and randomly disposed, and a filtration layer having a nanonet layer having a most frequent pore size from 1 nm to 100 nm in the pore size distribution, in which an anisotropic nanomaterial is disposed. The fiber-based filter may have excellent filtration efficiency capable of removing even super-fine particles such as virus and heavy metal, and may show high permeation flow rate due to low loss of pressure during the filtration, and may be usefully used as an air and water-treatment filter.

### CROSS-REFERENCE TO RELATED APPLICATION

This application claims priority to and the benefit of Korean Patent Application No. 10-2012-0104542 filed in the Korean Intellectual Property Office on Sep. 20, 2012, the entire contents of which are incorporated herein by reference.

### BACKGROUND OF THE INVENTION

(a) Field of the Invention

A fiber-based filter with a nanonet layer and a preparation method thereof are provided.

(b) Description of the Related Art

In a water purification system, a membrane filter that separates fine particles by a film having pores smaller than particles to be filtered is generally used, and examples of the membrane filter include microfiltration (MF; pore size 50 nm to 2,000 nm), ultrafiltration (UF; pore size 1 nm to 200 nm), reverse osmosis (RO; pore size 0.1 nm to 2 nm) used in desalination, and the like. Such a membrane-based liquid filter and separation technology are useful in the water treatment field such as oil/water emulsion separation or water desalination. However, when a general membrane filter is used to remove ultra-fine particles such as virus and the like, the loss of pressure caused by small pores is increased to a very high level, the flux is decreased due to low permeability, and pores of the film may be blocked during the use thereof to sharply decrease the permeation rate. Further, a general membrane filter requires frequent backwashing, and thus is limited by various temperature applications during the removal of impurities, energy consumption is high, and a material for the separation filter itself is not strong, thereby destroying the separation filter or increasing the size of pores.

Meanwhile, a fiber filter in the related art has low filtration precision and may not remove virus and the like in water, and thus, it is difficult to use the fiber filter in the water treatment precision filtration. For example, in the case of a melt-blown non-woven fabric which is currently and universally applied to filters, the diameter of a constituent fiber is so large that nano-sized particles such as virus and the like may not be filtered. Further, even when a polymer blend fiber is prepared by a melt-blown method and sea components are removed to prepare a super-micro fiber having a diameter distribution from 5 nm to 500 nm, a fiber having a large diameter is intermixed to form large pores, and thus filtration precision is decreased and it is difficult to remove the virus and the like in water.

In order to improve the situation, Japanese Patent Laid-Open Publication No. 2008-136896 discloses a water treatment filter prepared by cutting a super-micro fiber obtained by extrusion using a polymer blend and making paper. A nanofiber is prepared by blend spinning, and then cut into a size of approximately 2 mm length to prepare a filtration layer composed of paper by a paper-making method.

In addition, Japanese Patent Application Laid-Open No. 2009-148748 discloses a filter prepared by deposition of a polymer nanofiber on a non-woven fabric in the related art by electrospinning. A ultra-fine fiber having a fiber diameter of several hundred nm may be prepared by the electrospinning method, and a filter composed of the thus-prepared ultra-fine fiber may remove fine materials which would not be obtained in a fiber filter in the related art and the operating pressure of the filter is significantly lower than that of a precision filtration filter using a porous film.

When a pore size of the filtration layer is extremely small, ultra-fine particles such as a virus may be filtered with high efficiency, but it is difficult to prepare a filter having a pore size as small as the size. That is, the pore size depends greatly on the diameter of a nanofiber and the porosity, and thus it is difficult to prepare a nanofiber having a diameter which is small enough to filter ultra-fine particles such as virus and the like. Further, a filtration layer having the ultra-fine pores has very high filtration efficiency, but the pore size thereof is so small that high operating pressure may be required, the loss of pressure may be too great, and the flux may be too low. Accordingly, the filtration efficiency is increased, but the permeation capacity is reduced to a very low level, and thus it may be difficult to simultaneously satisfy high filtration efficiency and high flux.

A filter having pores with a size of approximately 60 nm or more may solve a problem caused by water contamination. A filter having the selectivity may remove bacteria or pathogenic virus from a drinking water supply source, an air supply source or blood. Recently, since the emergence of Severe Acute Respiratory Syndrome (SARS) and avian influenza, a need for a breathing mask capable of removing the virus is demanded. The size of virus is approximately 80 nm to 200 nm, and thus the pore size of a filter has a size capable of removing the virus.

A ceramic nanofilter may be used in order to remove ultra-fine particles, and the ceramic nanofilter may be generally prepared by a sol-gel method of a metal oxide precursor. However, the drawback of the sol-gel method is that irregular particles are formed and thus it is extremely difficult to control the pore size. Further, during the drying process by the sol-gel method, pinholes and cracks are generated, the length of pores is increased, thereby decreasing the flux, and low porosity and the presence of dead end pores may make it difficult to prepare a ceramic filter having high selectivity and high flux. In addition, a filter only using a ceramic super-micro fiber has brittle characteristics of a ceramic material as it has, and thus, mechanical properties of the filter may be weak and when the thickness of the filter is increased in order to overcome the problem, the flux may be sharply decreased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Thus, because the diameter of a ultra-fine fiber prepared by electrospinning has a limitation, and thus it is difficult to obtain a pore size and a pore size distribution, which are capable of removing virus, the present inventors have made a filter material that is capable of filtering ultra-fine particles such as a virus and the like and simultaneously satisfy high filtration efficiency/high flux by introducing a nanonet layer composed of an anisotropic nanomaterial into a ultra-fine fiber-based porous body to be used as a filtration layer.

An exemplary embodiment may provide an ultra-fine fiber-based filter that has excellent filtration efficiency capable of removing even ultra-fine particles such as a virus and shows a high flux due to low loss of pressure during the filtration by introducing a nanonet layer made of an anisotropic nanomaterial into an ultra-fine fiber-based porous body to form a filtration layer.

An exemplary embodiment may provide a method for preparing an ultra-fine fiber-based filter.

An exemplary embodiment may be used to achieve other problems which have not been specifically mentioned in addition to the problem.

An exemplary embodiment may provide an ultra-fine fiber-based filter that is capable of removing even ultra-fine particles such as virus and shows excellent filtration efficiency and high flux by introducing a nanonet layer made of an anisotropic nanomaterial into an ultra-fine fiber-based porous body to form a filtration layer, and a preparation method thereof.

A ultra fine fiber-based porous body may be prepared by electrospinning a polymer solution, a metal oxide precursor sol-gel solution, or a mixed solution of a sol-gel solution of a metal oxide in a polymer resin, and the ultra-fine fiber-based porous body may be used as a filtration layer by controlling the diameter of the ultra-fine fiber, the pore size and pore size distribution of the porous body.

An exemplary embodiment may provide a ultra-fine fiber-based filter, in which a ultra-fine fiber is continuously and randomly arranged and accumulated by electrospinning a polymer solution, a metal oxide precursor sol-gel solution, or a mixed solution of the polymer solution and a sol-gel solution of a metal oxide, a ultra-fine fiber-based porous body having a most frequent pore size from approximately 0.1 μm to 2 μm in a pore size distribution is included as a filtration layer, and the filtration layer contains a nanonet layer composed of an anisotropic nanomaterial.

Another exemplary embodiment may provide a method for preparing an ultra-fine fiber-based filter, including: forming a nanonet layer formed by spraying a dispersion liquid of an ultra-fine fiber-based porous body prepared by electrospinning and an anisotropic nanomaterial in the porous body.

A filter according to an exemplary embodiment may have excellent heat resistance and mechanical properties, and may show high flux while simultaneously having excellent filtration efficiency capable of removing a virus in water and air and low loss of pressure during the filtration, and thus may be used usefully as an air and water treatment filter.

### BRIEF DESCRIPTION OF THE DRAWINGS

FIG. 1 is a view of an average pore size and a pore size distribution according to the thickness of an ultrafine fiber-based filer.

FIGS. 2a to 2c are views of scanning electron microscope (SEM) photos of filters having different porosities by hot pressing and average pore sizes and pore size distributions thereof.

FIG. 3 is a dispersion liquid of bohemite nanofiber prepared according to Example 1-1 and a scanning electron microscope (SEM) photo illustrating a nanonet layer formed by filtering the same.

In FIGS. 4a and 4b, according to Example 1-2, FIG. 4a is a dispersion liquid of a bohemite/carbon nanotube complex prepared by hydrothermal synthesis of bohemite in the presence of carbon nanotubes for about 12 hours and a transmission electron microscope (TEM) photo thereof, and FIG. 4b is a scanning electron microscope (SEM) photo illustrating a nanonet layer formed by filtering a dispersion liquid prepared by reacting the same for about 22 hours.

FIGS. 5a and 5b are scanning electron microscope (SEM) photos illustrating a nanonet layer (FIG. 5b) formed by electrospray of a dispersion liquid of bohemite nanofiber in a SiO₂/PVdF ultra-fine composite fiber-based porous body (FIG. 5a) according to Example 2-1.

FIG. 6 is a scanning electron microscope (SEM) photo illustrating a nanonet layer formed by electrospray of a dispersion liquid of a bohemite/carbon nanotube complex in a PVdF/PAN ultra-fine composite fiber-based porous body according to Example 2-2.

FIGS. 7a to 7d are scanning electron microscope (SEM) photos illustrating nanonet layers formed by air-spray of a dispersion liquid of bohemite nanofiber by varying the spray amount to a silica ultra-fine fiber-based porous body (FIG. 7a) according to Example 2-3.

FIGS. 8a to 8d are scanning electron micro (SEM) photos illustrating a bohemite nanonet layer (FIG. 8a) in a silica/PVdF complex super-micro fiber-based filter, a silica/PVdF complex super-micro fiber layer (FIG. 8b) on both surfaces thereof and a silica/PVdF complex super-micro fiber-based filter (FIG. 8c) which is subjected to hot pressing to have a porosity of about 52%, and pore sizes and pore size distributions thereof (FIG. 8d), according to Example 3-1.

FIGS. 9a to 9b are a scanning electron microscope (SEM) photo illustrating a bohemite nanonet layer (FIG. 9a) partially formed in a silica/PVdF ultra-fine composite fiber-based filter, and pore sizes and pore size distributions thereof (FIG. 9b), according to Example 3-2.

FIGS. 10a and 10b are scanning electron microscope (SEM) photos illustrating a filter having two bohemite nanonet layers (FIG. 10b) in an m-aramid/PVdF ultra-fine fiber-based filter (FIG. 10a), according to Example 3-3.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification. Further, the detailed description of the widely known technologies will be omitted.

Then, an ultra-fine fiber-based filter having a nanonet layer made of an anisotropic nanomaterial according to exemplary embodiments will be described in detail.

According to an exemplary embodiment, a fiber-based filter may be provided, in which a ultra-fine fiber having an average fiber diameter from approximately 100 nm to 3,000 nm, which is formed by electrospinning a polymer solution, a metal oxide precursor sol-gel solution, or a mixed solution of the polymer solution and a sol-gel solution of a metal oxide, is continuously and randomly arranged and accumulated, a ultra-fine fiber-based porous body having a most frequent pore size from about 0.1 μm to about 2 μm in a pore size distribution is included as a filtration layer, and the filtration layer contains a nanonet layer formed by spraying a dispersion liquid of an anisotropic nanomaterial having an average diameter from about 1 nm to about 100 nm. In addition, the most frequent pore size in the pore size distribution of the ultra-fine fiber-based porous body may be about 0.1 μm to 2 μm.

According to another embodiment, a method for preparing an ultra-fine fiber-based filter may be provided, and the method may include forming a nanonet layer formed by spraying a dispersion liquid of an anisotropic nanomaterial in the ultra-fine fiber-based porous body prepared by electrospinning.

Examples of the anisotropic nanomaterial forming a nanonet layer made of a network structure may include a metal oxide including bohemite (AlOOH), aluminum hydroxide (Al(OH)₃), γ-alumina (γ-Al₂O₃), titanium dioxide (TiO₂), zinc oxide (ZnO) and the like, carbon nanofiber, single wall carbon nanotube (SWCNT), double wall carbon nanotube (DWCNT), multi-wall carbon nanotube (MWCNT), carbon nanorod, graphite nanofiber, or a mixture thereof.

The ratio of the length to the average diameter of the anisotropic nanomaterial may be from about 50 to about 3,000, a dispersion liquid of the anisotropic nanomaterial may be sprayed by an electrospray method that sprays the dispersion liquid under a high voltage electric field or an air-spray method that sprays the dispersion liquid with air pressure, and the most frequent pore size in the pore size distribution of the nanonet layer in which the anisotropic nanomaterial forms a network structure may be from about 1 nm to about 100 nm.

The anisotropic nanomaterial forms a nanonet layer, and then a small amount of a polymer binder may be added to the dispersion liquid of the anisotropic nanomaterial in order to improve breaking characteristics. However, when the amount of the binder is excessively large, the pore structure of the nanonet layer may be closed, and thus, it may be preferred that the binder is used in the smallest amount.

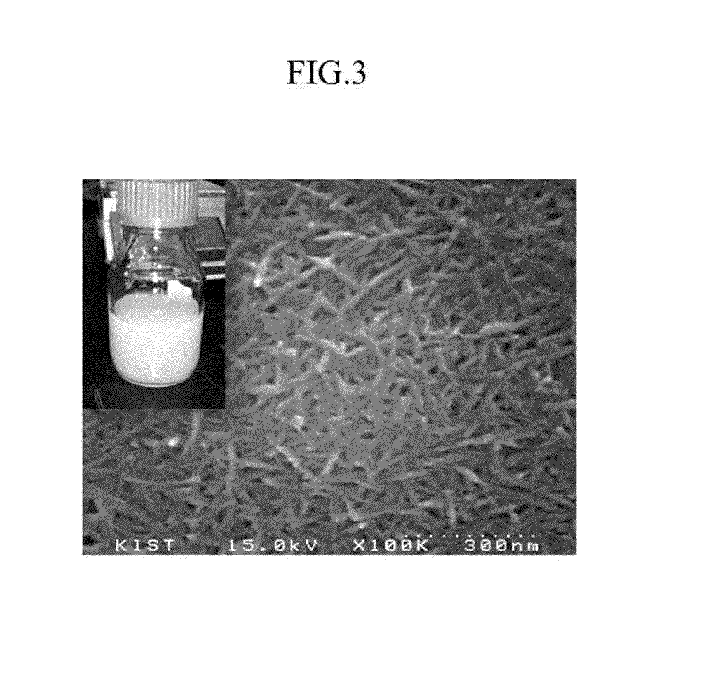

FIG. 3 illustrates a dispersion liquid of bohemite used in an exemplary embodiment and a bohemite nanonet layer formed when the dispersion liquid is filtered. FIG. 4a is a dispersion liquid of a bohemite/carbon nanotube complex prepared by hydrothermal synthesis of bohemite in the presence of carbon nanotubes for about 12 hours and a transmission electron microscope (TEM) photo thereof, and FIG. 4b is a scanning electron microscope (SEM) photo illustrating a nanonet layer formed by filtering a dispersion liquid prepared by reacting the same for about 22 hours. Referring to FIGS. 3 and 4, when the dispersion liquid of the anisotropic nanomaterial forming the nanonet layer is electrosprayed or air-sprayed on various ultra-fine fiber-based porous bodies, a nanonet structure is formed on the pore structure of the fiber-based porous body.

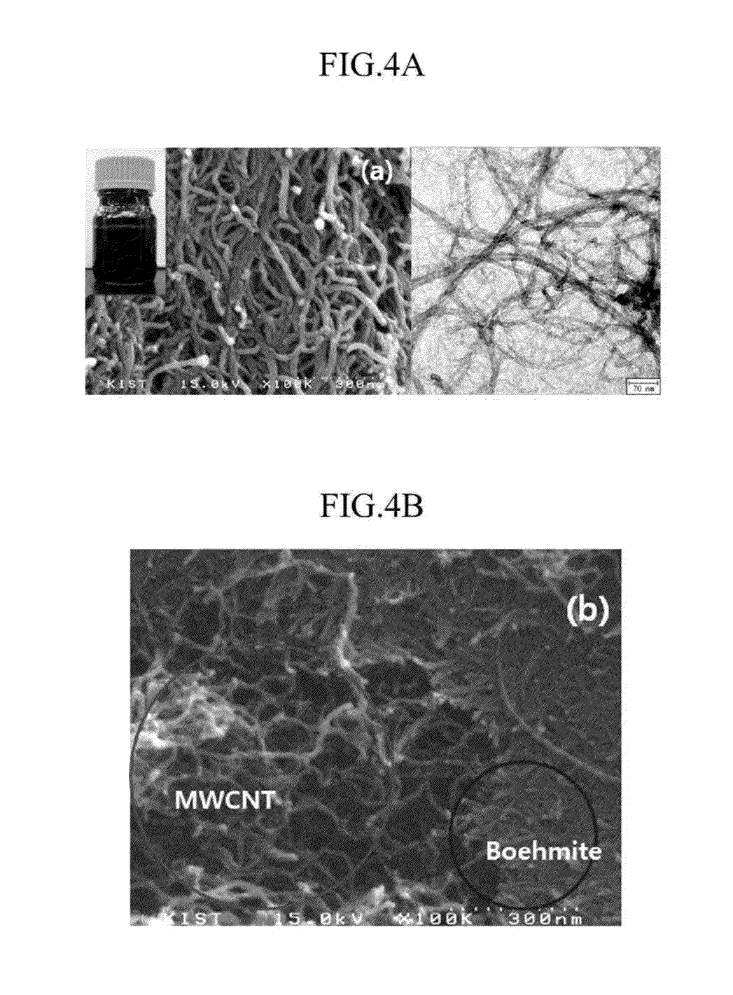

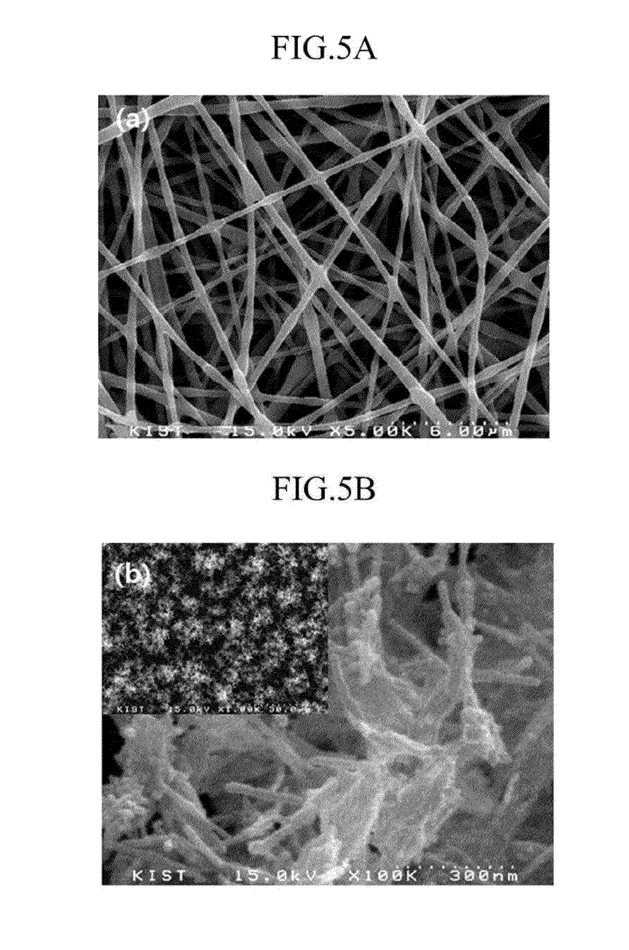

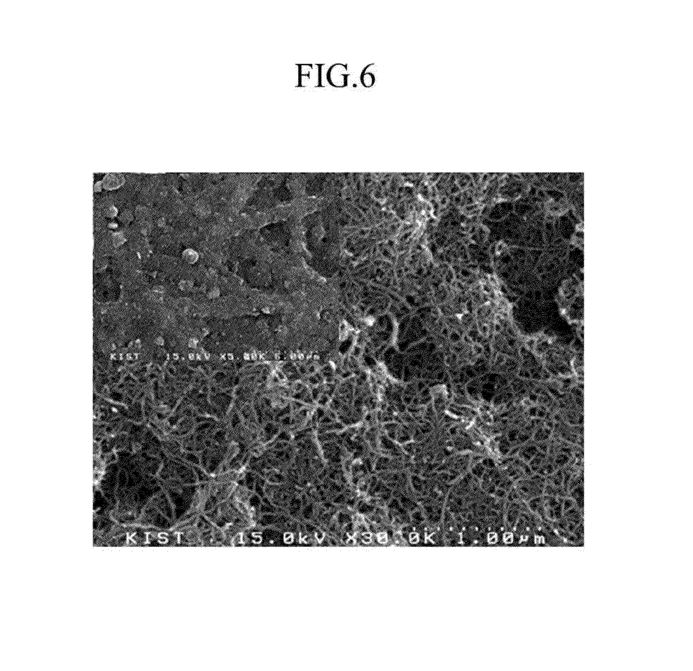

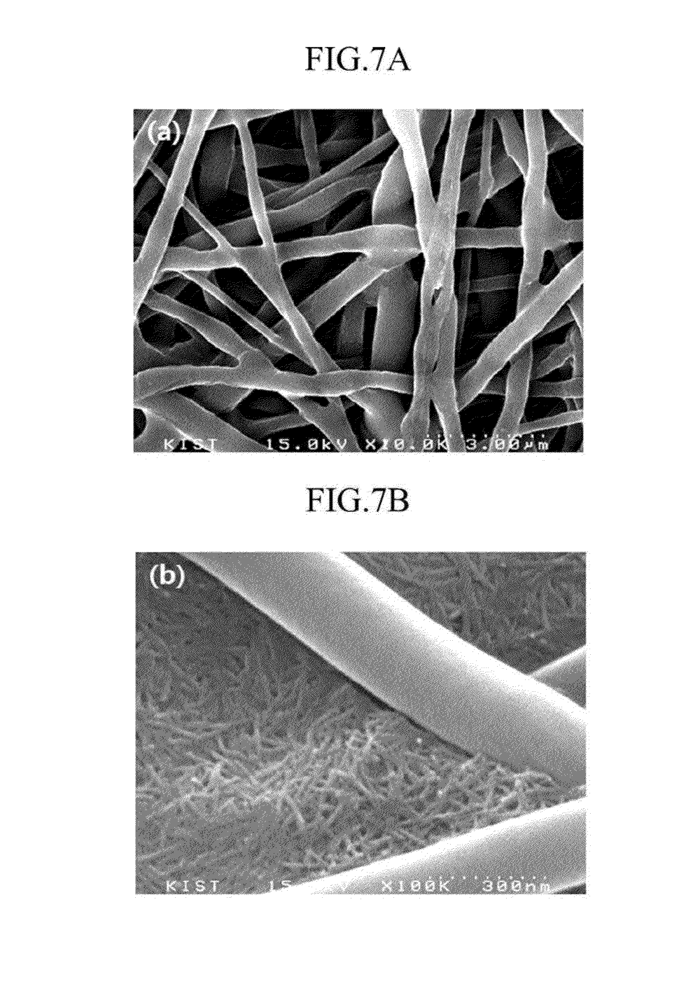

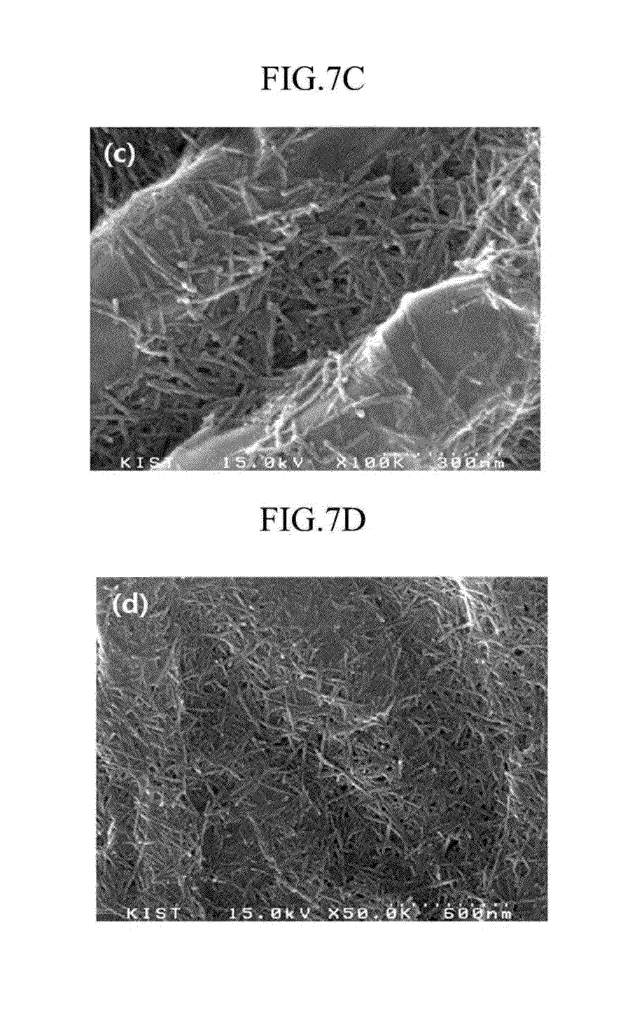

Referring to FIGS. 5 and 6, when a dispersion liquid of bohemite nanofiber is electrosprayed on each of the SiO₂/PVdF ultra-fine composite fiber-based porous body and when a dispersion liquid of the bohemite/carbon nanotube complex is electrosprayed on the PVdF/PAN ultra-fine composite fiber-based porous body, a nanonet layer is formed. Referring to FIG. 7, when a dispersion liquid of the bohemite nanofiber is air-sprayed on the silica ultra-fine fiber-based porous body in different spray amounts, the thickness of the bohemite nanonet layer may be controlled depending on the spray amount.

The thickness and porosity of the ultra-fine fiber-based porous body formed by electrospinning the precursor solution, and the diameter of the constituent fiber are factors that affect filter performance. When the thickness of the ultra-fine fiber-based porous body is increased, the filtration efficiency of the filter may be increased, but the permeation path may be elongated, thereby reducing the flux.

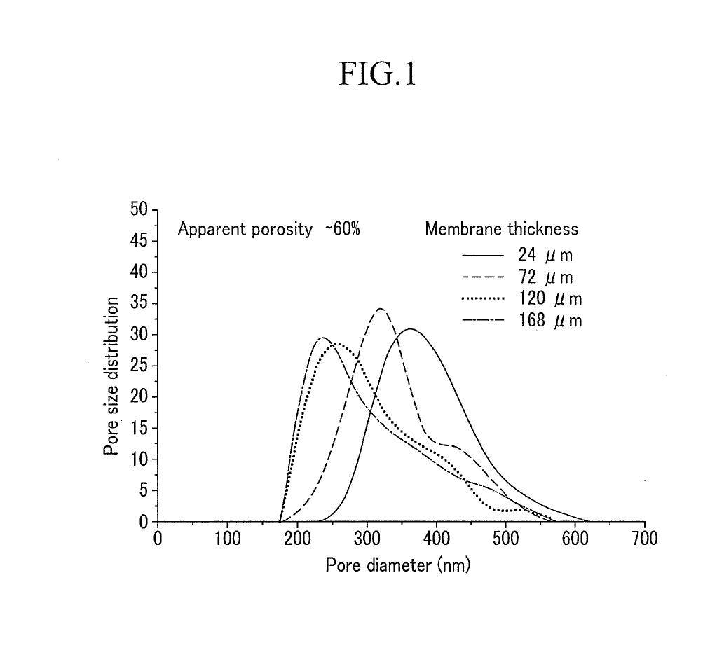

As known from the following Comparative Example 1, Table 1 and FIG. 1, when the thickness of the filter is increased while maintaining the same porosity, the average pore size is decreased, but the distribution of the pore size is not greatly decreased. Even though the thickness of the filter is increased, large pores do not disappear, indicating that the filtration efficiency of fine particles is not increased.

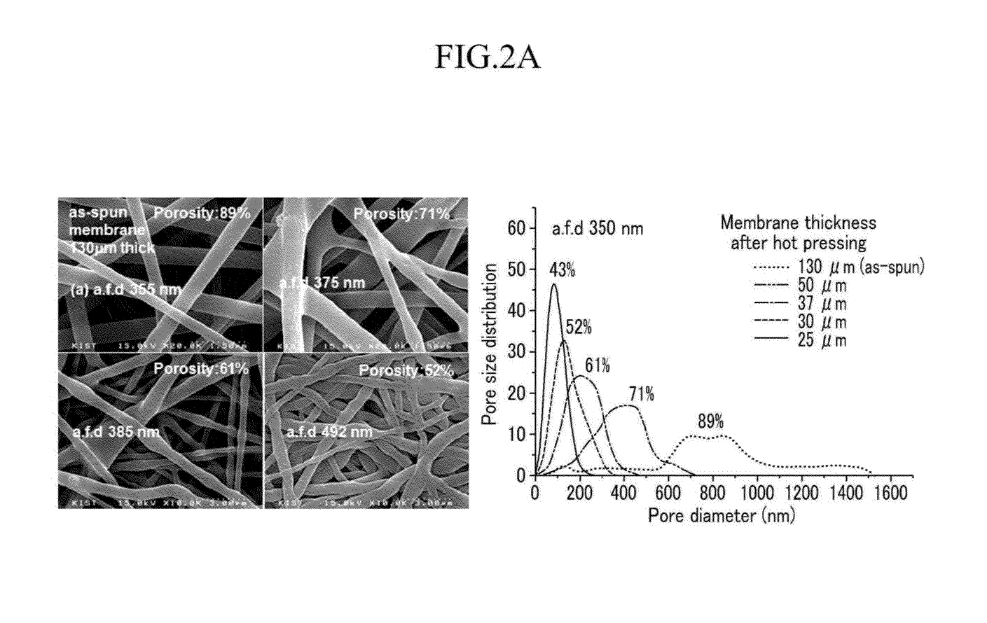

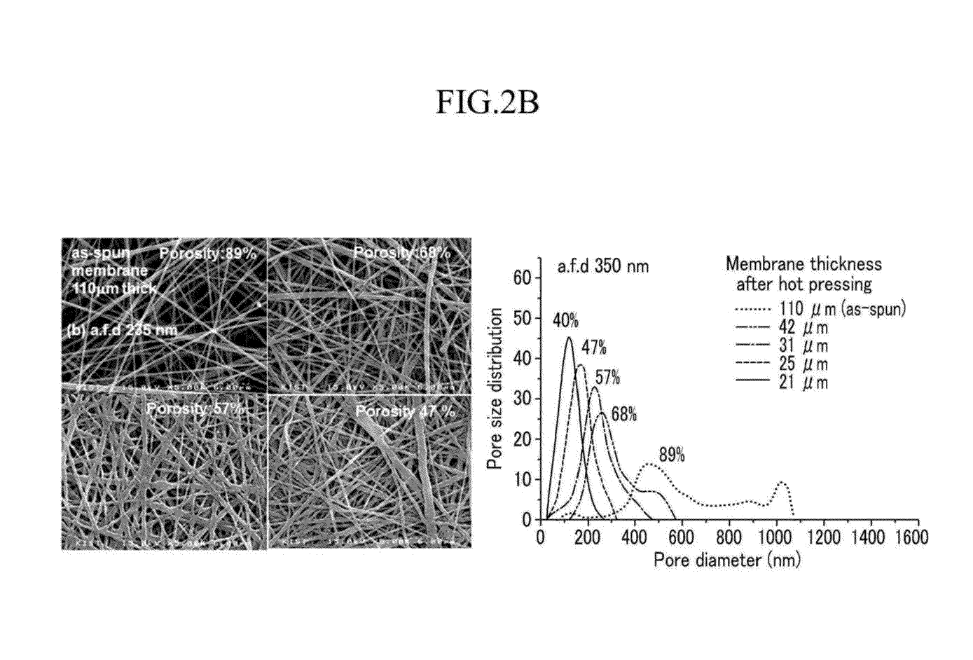

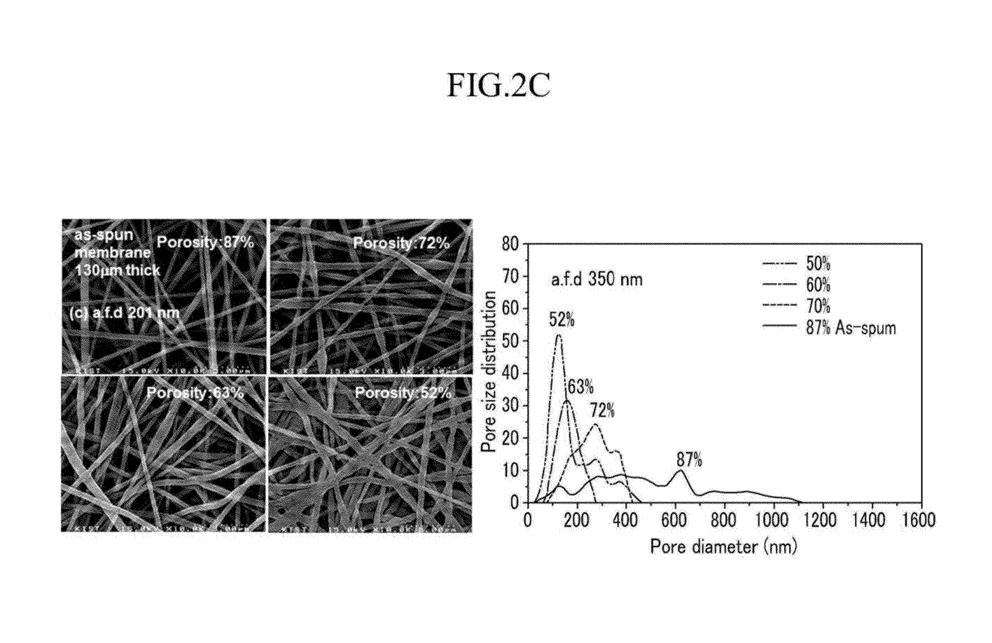

As known from Comparative Example 2, when the porosity of the filter is decreased, the pore size and the pore size distribution may be sharply decreased, thereby increasing the filtration efficiency of fine particles. However, as known form Table 2 and FIG. 2, the filtration efficiency may be increased, but a decrease in porosity may decrease the flux. Further, the process of pressing the porous body in order to reduce the porosity may increase the diameter of the constituent fiber, which leads to an increase in the permeation resistance of the flow rate, thereby decreasing the flux. When the average diameter of the fiber constituting the filter is decreased, the pore size and the pore size distribution are decreased, but the decrease in the flux thereof is smaller than that of a filter with a larger average fiber diameter according to the decrease in porosity, and thus the filtration efficiency of fine particles may be increased under a smaller loss of the flux.

The filtration precision of the filter, that is, the filtration efficiency and the flux are affected by the porosity and pore size of the filtration layer. As known from Comparative Example 2, the pore size, pore distribution and porosity of the ultra-fine fiber-based porous body, which is a filtration layer, are affected by the average diameter and diameter distribution of the constituent fiber. The smaller the fiber diameter is, the smaller the pore size is and also the smaller the pore size distribution is. Further, the smaller the diameter of the fiber is, the larger the specific surface area of the fiber is, and thus the ability to capture fine particles contained in a filtrate in the filter may also be increased.

In the case of a membrane filter, the pore size and porosity on the surface thereof may be different from the pore size and porosity inside of the membrane. This is due to the difference in evaporation of the solvent or elution rate on the surface of and in the membrane in the preparation process of the membrane, and dead end pores which fail to contribute to filtration are present. However, in the case of a filter composed of a fiber, the pore size and porosity of the surface thereof do not show a great difference from those of the filter bulk, nor dead end pores are present. The porosity is not a direct factor to the performance evaluation of the filter, but when the porosity is high, the flux may be high. Therefore, as a method of controlling the pore size such that the filtration layer in the filter may have high filtration efficiency and high flux, there is a method of controlling the diameter of the constituent fiber.

The fiber-based porous body constituting the filtration layer may have an average fiber diameter in a range from about 100 nm to about 3,000 nm. For example, ultra-fine fiber-based porous body constituting the filter is composed by continuously and randomly arranging and accumulating a ultra-fine fiber formed by electrospinning a polymer solution, a metal oxide precursor sol-gel solution, or a mixed solution of the polymer solution and a sol-gel solution of a metal oxide, and the ultra-fine fiber-based porous layer may include a ultra-fine fiber-based porous body having a most frequent pore size from about 0.1 μm to about 2 μm in the pore size distribution of the ultra-fine fiber-based porous body as a filtration layer by reducing porosity through the pressing process as in Comparative Example 2 or minimizing the average fiber diameter of the initial ultra-fine fiber.

In general, as the fiber diameter of a fiber-based porous body prepared by electrospinning becomes thin, the porosity and pore size thereof are not proportionally decreased. That is, the porosity and pore size are not greatly decreased, compared to the decrease in fiber diameter. It is required that the pore size is from about 1 nm to 100 nm in order to filter ultra-fine particles such as virus, but it is very difficult to reduce the pore size of a fiber-based porous body prepared by electrospinning to this level. When a porous body having a small pore size like this is prepared, high filtration efficiency may be obtained, but the flux is significantly decreased due to low permeation rate. Therefore, these ultra-fine polymer fiber-based porous bodies may be subjected to hot pressing in a range from the glass transition temperature (Tg) to the melting temperature (Tm) of the polymer at a level that big loss is not generated in the flux, thereby decreasing the porosity and pore size. In general, when a fiber-based porous body composed only of a polymer by electrospinning is subjected to hot pressing, the porosity may be decreased even to about 20% or less, and when the fiber-based porous body is subjected to further hot pressing, the pore structure may be almost collapsed by the melting of polymer components.

However, in the pore size distribution of the entire filtration layer, the filtration layer has not only single-sized pores, but also small pores and large pores, if necessary. For example, a bottom layer may be a porous layer with a large pore size, which is composed of a fiber having a larger diameter and may be a porous layer having pores with a small size, which is composed of a fiber having a smaller diameter on the upper layer thereof, and the porous layer may have a multi-layer structure or a gradient structure. Formation of a filtration layer having a multi-layer structure or a gradient structure may be achieved by first accumulating a fiber having a large diameter, and then accumulating a fiber having a gradually smaller diameter, during the electrospinning process.

In order to filter ultra-fine particles such as virus with high efficiency, the pore size of the filtration layer may from about 1 nm to 100 nm and more preferably from about 1 nm to about 60 nm. However, in order for the filtration layer to have a fine pore size of about 0.1 μm or less, which is capable of filtering virus, the flux may be decreased when the porosity is extremely reduced, and it may be difficult to reduce the average fiber diameter to about 100 nm or less by electrospinning.

Accordingly, the filter according to an exemplary embodiment may include a ultra-fine fiber-based porous body filtration layer having a most frequent pore size from about 0.1 μm to about 2 μm, and the filtration layer includes a nanonet layer formed by spraying a dispersion liquid of an anisotropic nanomaterial having an average diameter from about 1 nm to about 100 nm. The nanonet layer having a network structure may have a most frequent pore size from about 1 nm to about 100 nm in the pore size distribution.

A filtration layer of the filter may be prepared by subjecting a porous body composed of a ultra-fine fiber having an appropriate average fiber diameter to hot pressing in a range from the glass transition temperature (T₉) to the melting temperature (Tₘ) of the polymer and spraying a dispersion liquid of an anisotropic nanomaterial on a porous body in which the porosity and porosity size distribution is controlled in advance to form a nanonet layer.

Further, a filtration layer of the filter may be prepared by stacking a ultra-fine fiber layer to a predetermined thickness during the electrospinning process of preparing a ultra-fine fiber-based porous body, then stacking a nanonet layer, subjecting the porous body, in which the ultra-fine fiber layer is stacked on the nanonet layer to a predetermined thickness, to hot pressing, and controlling the pore size and pore size distribution of the ultra-fine fiber-based porous body. In this case, the nanonet layer may have a multi-layer structure in addition to a single-layer structure.

In addition, a porous body in which a ultra-fine fiber layer and a nanonet layer are intermixed may be prepared by simultaneously stacking the ultra-fine fiber layer and spraying the nanonet dispersion liquid during the electrospinning process, and a filtration layer of the filter may be prepared by controlling the pore size and pore size distribution of the ultra-fine fiber-based porous body by hot pressing.

However, the filtration layer having super-fine pores have very high filtration efficiency, but may have low flux due to great loss of pressure. Therefore, it may not be preferred that only the pore size of the filtration layer is used to filter super-fine particles such as virus. Bohemite may adsorb virus, and thus even though the pore size of the filtration layer is not excessively reduced when the nanonet layer contains bohemite, the flux may be increased.

According to an exemplary embodiment, the polymer resin is not particularly limited as long as the polymer resin is one of polymers used as a filter material. For example, polyacrylonitrile and copolymers thereof, polyvinylalcohol and copolymers thereof, polyvinylidene fluoride and copolymers thereof, cellulose and copolymers thereof, and the like may be used. In addition to these polymers, a highly heat-resistant resin including polyvinylpyrrolidone, aramid, polyamideimide, polyetherimide, polyimide, polyamide, polyphenylenesulfone, polyethersulfone, polyetheretherketone and the like may be used, and in this case, heat resistance may be further improved. Further, like sulfonated polyetheretherketone (SPEEK), sulfonated polysulfone and the like, a polymer resin having —SO₃H, COOH or an ionic functional group or copolymers thereof may be used. In addition, two or more polymers may be mixed and the mixture may be used.

In the case of a ultra-fine fiber composed of a mixture of two or more polymers, the ultra-fine fiber may have a multi core-shell structure in which one component is formed as a core structure and the other component(s) is(are) formed as a shell structure when having a property that each polymer component is not mixed well with each other. In this case, a hydrophilic component may be introduced into the shell structure according to the selection of different polymers. Further, when a heat-resistant polymer is introduced into the core structure, an ultra-fine polymer fiber with improved heat resistance may be provided. In this case, when the shell-component polymer is a polymer capable of being molten, fusion may occur between ultra-fine fibers during the hot pressing process for controlling the porosity, thereby increasing the mechanical strength of the filter.

A metal oxide ultra-fine fiber may be an ultra-fine fiber composed of a metal oxide including silica, alumina, titanium dioxide, zirconia, or a mixture thereof, and the like. The precursor of the metal oxide is represented by M(OR)x, MRx(OR)y, MXy or M(NO₃)y, where, M is Si or Al or Ti or Zr, R is a C₁-C₁₀ alkyl group, X is F, Cl, Br or I, and x and y may be an integer of 1 to 4, and the metal oxide may also be prepared from a sol-gel reaction solution of these precursors thereof.

Further, the polymer and metal oxide-mixed ultra-fine fiber may be prepared from a mixed solution of a sol-gel solution of the metal oxide precursor and the polymer. For example, in the case of a polymer which is melted or has a low glass transition temperature, or a polymer which is thermally decomposed before being melting, when a fiber is formed from a silica precursor sol-gel solution, an alumina precursor sol-gel solution, a titanium dioxide precursor sol-gel solution, or a solution in which a sol-gel solution of a mixture thereof and a polymer resin are mixed according to an exemplary embodiment, the morphological stability of the fiber may be maintained even at a temperature which is much higher than the melting point or glass transition temperature of the polymer resin, and the thermal decomposition temperature of the fiber may be greatly increased, and thus heat resistance may be increased.

Further, the metal oxide ultra-fine fiber alone has excellent heat resistance, but has a brittle characteristic. However, according to an exemplary embodiment, the polymer and metal oxide-mixed ultra-fine fiber may have flexibility as an ultra-fine fiber prepared from a mixed solution of a sol-gel solution of the metal oxide precursor and the polymer. The internal structure of the ultra-fine fiber according to an embodiment may be a skin multicore-shell nanostructure in which the metal oxide component forms a surface layer (skin layer) of a ultra-fine fiber, the polymer component forms a shell layer in the surface layer, and the metal oxide forms a multi-core, or may be a multicore-shell nanostructure in which the polymer component forms a shell layer without the surface layer and the metal oxide forms a multi-core. An ultra-fine fiber having the nanostructure may have heat resistance that a metal oxide has while maintaining flexibility that the polymer fiber has, and may have excellent ability to adsorb bohemite.

When the ultra-fine fiber is a metal oxide alone or a mixture of a polymer and a metal oxide, the sol-gel reaction may be completed by performing hot pressing for controlling the porosity, and then performing heat treatment at a temperature from about 150° C. to about 350° C. The heat treatment process may dehydrate a metal oxide ultra-fine fiber-based porous body prepared by electrospinning. As the dehydration reaction proceeds, the polymer fiber-based porous body is shrunk during the heat treatment process, but after the dehydration reaction is completed, the shrinkage does not occur any more. When the heat treatment temperature exceeds about 350° C., a nanonet layer including aluminum hydroxide such as bohemite may be converted into alumina (Al₂O₃) during the heat treatment process.

The method of preparing an ultra-fine fiber is not particularly limited, but may include electrospinning a polymer solution, a sol-gel solution of a metal oxide precursor, or a mixed solution of the polymer solution and the sol-gel solution of the metal oxide precursor. Accordingly, an ultra-fine fiber having a smaller fiber diameter may be prepared, and the method may be applied to various kinds of polymer solutions, metal oxide precursor sol-gel solutions, or mixed solutions thereof.

The principle of electrospinning that forms the ultra-fine fiber is well described in various literatures [G. Taylor. Proc. Roy. Soc. London A, 313, 453 (1969); J. Doshi and D. H. Reneker, J. Electrostatics, 35 151 (1995)]. Unlike electrospray which is a phenomenon that a low-viscosity liquid is atomized into super-fine bubbles under a high-voltage electric filed that is equal to or higher than the threshold voltage, electrospinning allows a high-voltage electrostatic power to be applied to a polymer solution having a sufficient viscosity, a sol-gel solution of a metal oxide precursor or a mixture thereof, or a mixed solution of the sol-gel solution and a polymer, and a ultra-fine fiber may be formed by electrospinning. An electrospinning and electrospray device may be used in the same device, and the device may include a barrel that stores a solution, a metering pump that discharges the solution at a constant speed, and a spinning nozzle connected to a high voltage generator. A high-viscosity solution discharged through the metering pump is released into an ultra-fine fiber while passing through a spinning nozzle that is electrically charged by the high voltage generator, and a porous ultra-fine super-micro fiber-based web is accumulated on a current collector that is ground in the form of a conveyor that moves at a constant speed. An ultra-fine fiber having a size from several to several thousand nanometers may be prepared by electrospinning the solution, and it is possible to prepare a porous web having a form in which the fiber is produced and simultaneously fused into a 3-Dimensional network structure and stacked. The ultra-fine fiber-based porous body has a higher volume to surface area ratio than a fiber in the related art, and high porosity.

In the present specification, electrospinning includes melt-blowing, flash spinning or an electro-blowing method of preparing an ultra-fine fiber by a high voltage electric field and air-spray as a modification of the processes, and all of these methods include extrusion through a nozzle under an electric field.

According to an exemplary embodiment, a ultra-fine fiber having an average fiber diameter from approximately 100 nm to approximately 3,000 nm and formed by electrospinning a polymer solution, a metal oxide precursor sol-gel solution, or a mixed solution of the polymer solution and a sol-gel solution of a metal oxide is continuously and randomly arranged and accumulated, a ultra-fine fiber-based porous body having a most frequent pore size from approximately 0.1 μm to approximately 2 μm in the pore size distribution thereof may be included as a filtration layer in a filter, and the filtration layer may include a nanonet layer formed by spraying a dispersion liquid of an anisotropic nanomaterial having an average diameter from about 1 nm to about 100 nm.

Further, according to an exemplary embodiment, it is possible to prepare a filter material that may filter super-fine particles such as virus and the like and simultaneously satisfies high filtration efficiency/high flux by introducing a nanonet layer including bohemite capable of adsorbing super-micro particles such as heavy metal or virus into a filtration layer of the filter instead of not reducing the porosity of the filtration layer including fiber-based filter media in the related art.

Meanwhile, according to an exemplary embodiment, the form of a filter having a filtration layer into which a bohemite nano composite is introduced may be a form in which filters are stacked in a flat plate state, a pleats type, a spiral type and the like.

Hereinafter, the present invention will be described in detail with reference to Examples, but the following Examples are only the Examples of the present invention, and the present invention is not limited to the following Examples.

In the filters prepared in the Examples and Comparative Examples, the fiber diameter, pore size, porosity, filtration efficiency and permeation flow rate thereof are measured by the following methods.

1. Diameter of Fiber Constituting Filter

From SEM photos of the surface or cross-section of a heat resistant ultra-fine polymer fiber-based porous body, the diameter of the ultra-fine polymer fiber, the average diameter of the fiber and the fiber diameter distribution were measured by using Sigma Scan Pro 5.0, SPSS.

2. Pore Size of Super-Micro Polymer Fiber-Based Porous Body

A capillary flow porometer (manufactured by PMI Co., Ltd., version 7.0) was used to measure the average pore size in a pressure range from about 0 psi to about 30 psi, the pore size was calculated from a measured wet flow and dry flow curve, and perfluoro polyether (propene 1,1,2,3,3,3 hexafluoro, oxidized, polymerized) was used as a wetting agent.

3. Porosity Evaluation

The porosity evaluation of the heat resistant ultra-fine polymer fiber-based porous body was evaluated by a butanol infiltration method of the following equation.

Butanol Infiltration Method P (%)={(M_{BuoH}/ρ_{BuOH})/(M_{BuOH}/ρ_{BuoH}+Mₘ/ρₚ)}×100

(Absorbed BuOH weight, Mₘ: Heat resistant polymer fiber-based porous body weight, ρ_{BuOH}: BuOH density, ρₚ: heat resistant polymer fiber density)

4. Filtration Precision (Filtration Efficiency) Evaluation

About 30 mL of about 0.1% by weight of a suspended solution prepared by diluting about 10% by weight of a suspended aqueous solution of polystyrene latex particles (Magsphere Inc.) having diameters of about 200 nm and about 105 nm with deionized water was supplied such that the suspended solution was permeated through a heat resistant ultra-fine polymer fiber-based porous body by using a vacuum system so as to allow a pressure difference between a supplied liquid and a permeated liquid to be about 20 kPa. Thereafter, the concentration of latex nanoparticles contained in the original suspended solution and the permeated liquid permeating through the heat-resistant ultra-fine polymer fiber-based porous body was quantitatively evaluated as absorbance intensity at from about 200 nm to about 205 nm by a UV-visible spectrometer, and the filter efficiency was evaluated by the following equation. Further, about 5 μl of the permeated liquid was collected, put on a slide glass, and vacuum-dried, and then the number of latex particles was calculated to evaluate the filter efficiency.

Filter efficiency (%)=[1−(Cₜ/Cₒ)]×100

Cₜ: Concentration of permeated liquid latex particles, Cₒ: Concentration of original latex suspended solution

5. Flux Evaluation

A filter was mounted to a filter holder in the same manner as in the measurement of filtration precision, and a flux was measured by measuring the permeation time per about 5 mL of the permeated liquid permeating through the filter while deionized water at about 25° C. was supplied with a pressure difference of about 20 kPa.

### Comparative Example 1

### Preparation of Ultra-Fine Fiber-Based Filter

About 37.5 g of tetraethoxyorthosilicate (TEOS, Aldrich Corp.), about 16.0 g of methyltriethoxysilane (Aldrich Corp.), about 24.9 g of ethyl alcohol, about 9.6 g of water and about 0.28 g of a hydrochloric acid aqueous solution were mixed, and then the mixture was stirred at about 70° C. for about 3 hours to prepare about 31 g of a silica sol-gel solution. A porous body composed of a silica/PVdF ultra-fine composite fiber having a porosity of about 87% and an average fiber diameter of about 380 nm and having a thicknesses of approximately 63 μm, 189 μm, 315 μm and 441 μm was prepared by adding about 140 g of a DMF solution in which about 14 g of polyvinylidene fluoride (PVdF, Kynar 761) was dissolved to the prepared solution, and then electrospinning the mixed solution under a high voltage electric field of about 20 kV, a discharge rate of about 30 μl/min and a spinning nozzle of about 30 G. The prepared porous bodies having a porosity of approximately 60% were subjected to hot pressing at about 130° C., and then subjected to heat treatment at about 180° C. for about 10 minutes to prepare a fiber-based filter having final thicknesses of approximately 24 μm, 72 μm, 120 μm and 168 μm, and the pore sizes, distributions and permeabilities of the fiber-based filters are shown in Table 1 and FIG. 1.

When the thickness of the filter is increased while maintaining a similar porosity, the average pore size is decreased and the permeability is a little reduced. However, as shown in FIG. 1, the pore size distribution is not decreased, and thus the filtration efficiency may deteriorate due to the presence of large pores.

TABLE 1

| | | | Air | | |
|---|---|---|---|---|---|
| | | Apparent | Permeability | Average | Largest |
| Filter thickness (μm) | | porosity | (Gurley | pore | pore |
| Initial | After pressing | (%) | number) | size (nm) | size (nm) |
| 63 | 24 | 60 | 11 | 377 | 600 |
| 189 | 72 | 60 | 24.9 | 329 | 546 |
| 315 | 120 | 57 | 47.0 | 282 | 518 |
| 441 | 168 | 61 | 41.7 | 273 | 541 |

### Comparative Example 2

### Preparation of Super-Micro Fiber-Based Filter

The same spinning solution as that in Comparative Example 1 was used to perform electrospinning under the same conditions, but electrospinning was performed at discharge rates of approximately 25 μl/min, 15 μl/min and 10 μl/min to prepare porous bodies composed of ultra-fine fibers having average fiber diameters of 355 nm, 235 nm and 201 nm, and the porous bodies were subjected to hot pressing to prepare filters having different porosities. The pore sizes, distributions and permeabilities of the prepared filters are shown in Table 2 and FIG. 2.

TABLE 2

| | | | | Average | Air | | | Filtration | |
|---|---|---|---|---|---|---|---|---|---|
| | | | | fiber | Permeability | Average | Flux | efficiency (%), 20 kP¹⁾ | |
| | Filter | Thickness | Porosity | diameter | (Gurley | pore size | (L/hr/m²), | 200 nm | 105 nm |
| | sample | (μm) | (%) | (nm) | number) | (nm) | 20 kPa | particle ²⁾ | particle ²⁾ |
| 1 | Initial | 130 | 89 | 355 | 6 | 799 | — | | |
| | film | | | | | | | | |
| | After hot | 50 | 71 | 375 | 12 | 387 | 8100 | 11.9 | 6.9 4.1 |
| | pressing | | | | | | | 10.1 | |
| | | 37 | 61 | 385 | 28 | 198 | 979 | 40.4 | 9.8 |
| | | 30 | 52 | 492 | 66 | 138 | 596 | [76.4] | 30.4 |
| | | 25 | 43 | 529 | 190 | 87 | 176 | 85.9 | 51.8 |
| | | | | | | | | 88.0 | |
| 2 | Initial | 110 | 89 | 235 | 7 | 550 | — | | |
| | Filter | | | | | | | | |
| | After hot | 42 | 68 | 250 | 20 | 282 | 6966 | 32.6 | 13.2 |
| | pressing | 31 | 57 | 255 | 31 | 232 | 896 | 51.2 | 20.1 |
| | | 25 | 47 | 310 | 69 | 163 | 561 | 88.3 | 41.5 |
| | | 21 | 37 | 347 | 185 | 122 | 166 | 95.3 | 63.0 |
| 3 | Initial | 131 | 87 | 201 | 8 | 442 | — | | |
| | Filter | | | | | | | | |
| | After hot | 61 | 72 | 271 | 18 | 239 | 5812 | 48.9 | 31.0 |
| | pressing | 47 | 63 | 354 | 33 | 162 | 676 | 82.7 | 43.5 |
| | | 36 | 52 | 408 | 72 | 100 | 341 | 99.7 | 71.0 |

¹⁾1 cycle filtration,
²⁾ 100 ppm-polystyrene latex dispersed solution,
[ ]: thickness 105 μm, porosity 60%, flux 81 L/hr/m² (20 kPa),
( ): Commercial filter - porosity 75%, thickness 170 μm, air permeability 27.5, average pore size 188 nm, flux 2566 L/hr/m² (20 kPa),

When the pressing ratio is increased to reduce the porosity, the average pore size and distribution are decreased while large pores may disappear. However, an increase in pressing ratio may lead to an increase in average fiber diameter due to pressing of the constituent fiber, and accordingly, the air permeability and flux may be sharply decreased. When the average diameter of the initial constituent fiber is decreased, smaller pores and pore distributions may occur without a large loss even though the porosity is decreased by pressing. However, in order to decrease an initial average fiber diameter, the discharge rate needs to be greatly reduced during electrospinning, thereby reducing the productivity.

### Example 1-1

### Preparation of Bohemite Nanofiber

About 15 mL of aluminum butoxide [Al(O-secButyl)₃] was put into about 1,450 mL of distilled water, and about 10.9 mL of hydrochloric acid was added thereto to prepare a white dispersion liquid. About 38 g of aluminum isopropoxide [Al(O-isoPropyl)₃] was added to the white dispersion liquid, and then the mixture was ultrasonically stirred in an ice bath for about 1 hour. FIG. 3 is a scanning electron microscope (SEM) photo illustrating the surface of a bohemite nanofiber porous layer composed of a nanonet structure obtained by filtering the dispersion liquid.

FIG. 3 is a scanning electron microscope (SEM) photo illustrating the surface of a bohemite nanofiber porous layer composed of a nanonet structure obtained by filtering the dispersion liquid. Referring to FIG. 3, a bohemite nanonet layer may be introduced into the filter when dispersion liquid is used.

### Example 1-2

### Preparation of Bohemite/Carbon Nanotube Complex

About 15 mL of aluminum butoxide [Al(O-secButyl)₃] was put into about 1,450 mL of distilled water, and about 10.9 mL of hydrochloric acid was added thereto to prepare a white dispersion liquid. About 38 g of aluminum isopropoxide [Al(O-isoPropyl)3] and multi-wall carbon nanotube (MWCNT, supplied by Nanocyl Inc.) were added to the white dispersion liquid, and then the mixture was ultrasonically stirred in an ice bath for about 1 hour. The stirred solution was reacted at about 150° C. in a high pressure reactor connected with a Teflon tube for about 22 hours and 22 hours, and then white dispersion liquids as shown in FIG. 4 were prepared.

FIG. 4a illustrates a dispersion liquid of a bohemite/carbon nanotube complex obtained after reaction for about 12 hours and a transmission electron microscope (TEM) photo thereof. Referring to FIG. 4a, an aspect that bohemite is adsorbed on the surface of carbon nanotube is shown. FIG. 4b is a scanning electron microscope (SEM) photo illustrating the surface of a porous layer having a nanonet structure composed of bohemite/carbon nanotube obtained by filtering a dispersion liquid of a bohemite/carbon nanotube complex prepared by reaction for about 22 hours. Referring to FIG. 4b, an aspect that a bohemite nanofiber is grown and intermixed with carbon nanotube is shown, and dispersion liquid may be used to introduce a bohemite/carbon nanotube complex nanonet layer into the filter.

### Example 2-1

### Electrospray of Dispersion Liquid of Bohemite Nanofiber to SiO₂/PVdF Complex Ultra-Fine Fiber-Based Porous Body

The dispersion liquid of bohemite nanofiber prepared in Example 1-1 was sprayed on the SiO₂/PVdF ultra-fine composite fiber-based porous body prepared in Comparative Example 2 [FIG. 5a] through a spinning nozzle of about 27 G under a high-voltage electric field of 12 kV at a discharge rate of about 30 μl/min.

FIG. 5b illustrates a nanonet structure composed of a bohemite nanofiber formed on the surface of a fiber-based porous body.

### Example 2-2

### Electrospray of Dispersion Liquid of Bohemite/Carbon Nanotube Complex to PVdF/PAN Ultra-Fine Composite Fiber-Based Porous Body

The dispersion liquid of the bohemite/carbon nanotube complex of Example 1-2 [FIG. 4a] was sprayed on the surface of the PVdF/polyacrylonitrile (PAN, Mw polyccience, molecular weight of about 150,000) (1/1 weight ratio) ultra-fine composite fiber-based porous body having an average fiber diameter of about 650 nm, which is prepared by electrospinning through a spinning nozzle of about 27 G under a high-voltage electric field of about 10 kV at a discharge rate of about 25 μl/min.

FIG. 6 illustrates a nanonet structure of a bohemite/carbon nanotube complex formed on the surface of a fiber-based porous body.

### Example 2-3

### Air-Spray of Dispersion Liquid of Bohemite Nanofiber to Silica Ultra-Fine Fiber-Based Porous Body

About 37.5 g of tetraethoxyorthosilicate (TEOS, Aldrich Corp.), about 16.0 g of methyltriethoxysilane (Aldrich Corp.), about 24.9 g of ethyl alcohol, about 9.6 g of water and about 0.28 g of a hydrochloric acid aqueous solution were mixed, and then the mixture was stirred at about 70° C. for about 3 hours to prepare a silica sol-gel solution. The dispersion liquid of the bohemite nanofiber prepared in Example 1-1 was air-sprayed in an amount of approximately 10 mL, 20 mL and 30 mL on the surface of the silica nanofiber porous body having an average fiber diameter of about 280 nm in FIG. 7a, which was prepared by electrospinning the prepared silica sol-gel solution.

FIGS. 7b to 7d illustrate the nanonet structures of bohemites obtained by varying the spray amount.

### Example 3-1

### Preparation of Silica/PVdF Ultra-Fine Composite Fiber-Based Filter Having Bohemite Nanonet Layer

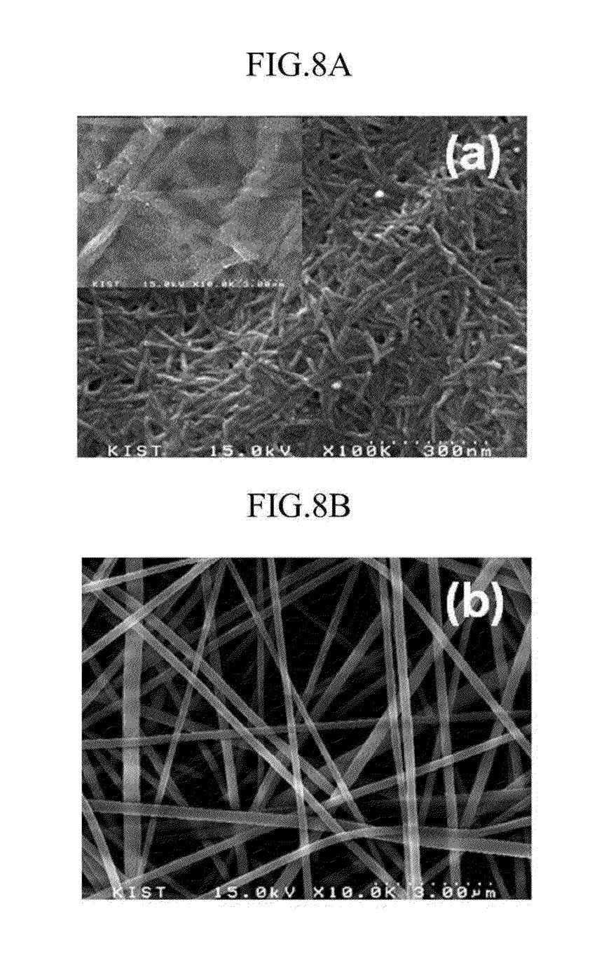

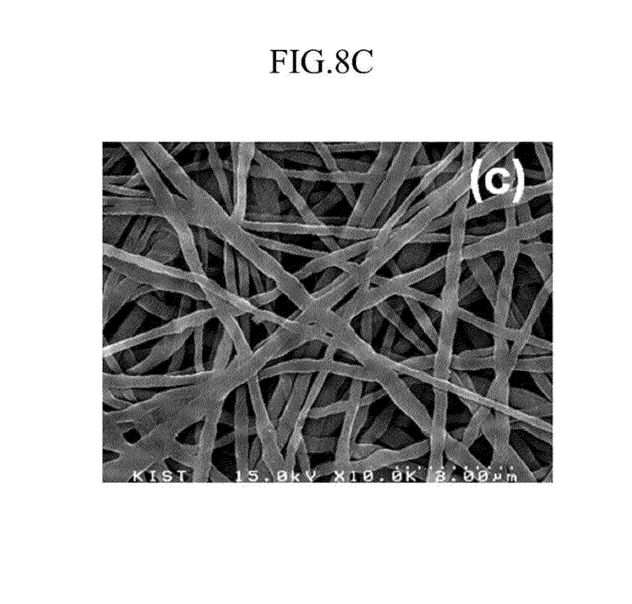

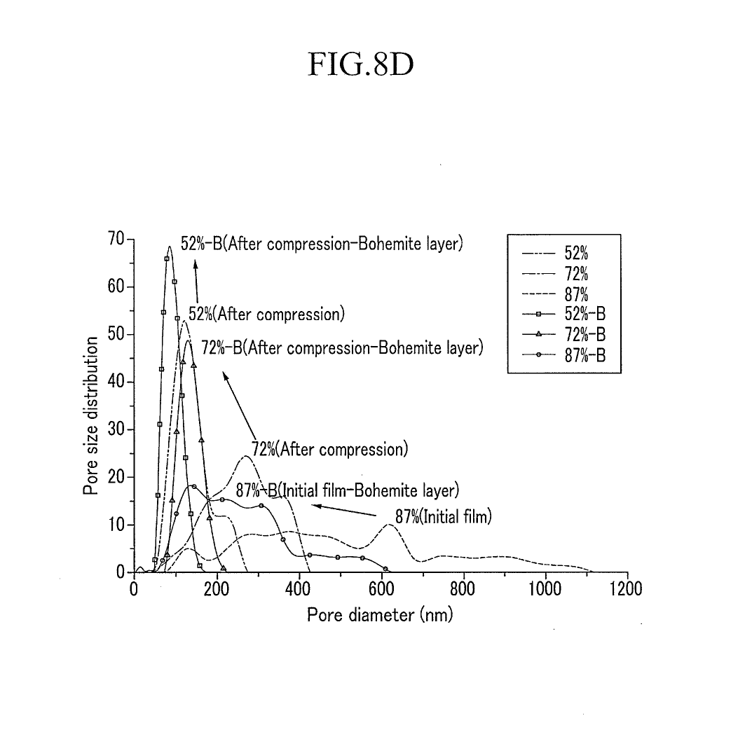

A porous body was prepared in the same manner as in preparation conditions of a porous body having a thickness of about 131 μm, which was composed of a silica/PVdF ultra-fine composite fiber having an average fiber diameter of about 201 nm in Comparative Example 2, but a silica/PVdF ultra-fine composite fiber layer of about 65 μm was first accumulated during the electrospinning process, then a dispersion liquid of the bohemite nanofiber was air-sprayed with an air pressure thereon in the same manner as in Example 2-3 to introduce a bohemite nanonet layer [FIG. 8a], and a silica/PVdF ultra-fine composite fiber layer of about 65 μm was again accumulated [FIG. 8b]. Even though the bohemite nanonet layer was introduced, the thickness of the silica/PVdF ultra-fine composite fiber-based porous body was not different from that of a porous body having no nanonet layer. The prepared porous body was subjected to hot pressing at about 130° C. and then subjected to heat treatment at about 180° C. for 10 minutes to prepare fiber-based filters [FIG. 8c] having final thicknesses of about 61 μm (porosity about 72%) and about 36 μm (porosity about 52%). The pore size and distribution of fiber-based filters in which the bohemite nanonet layer was introduced and was not introduced are shown in FIG. 8d. As shown in FIG. 8d, in the initial film with a porosity of about 87% having a similar film thickness and average fiber diameter, the average pore size and pore size distribution were sharply reduced by introducing a bohemite nanonet layer, and large pores were also significantly reduced. Further, in the case of pressing such that the porosity became approximately 72% and 52%, the pore size and pore size distribution decrease, and large pores disappeared. In particular, a nanonet layer was introduced to greatly reduce the pores having the most frequency from about 280 nm to about 128 nm in a porosity of about 72% and from about 125 nm to about 74 nm in a porosity of about 52%. The flux of the filter at a pressure of about 20 kPa were approximately 582 L/hr/m² and approximately 421 L/hr/m² in porosities of about 72% and about 52%, respectively, and the filter efficiencies of a polystyrene latex dispersion solution of about 102 nm at a concentration of about 100 ppm were 89.0% and 95.0%, respectively.

### Example 3-2

### Preparation of Silica/PVdF Ultra-Fine Composite Fiber-Based Filter Having Bohemite Nanonet Layer

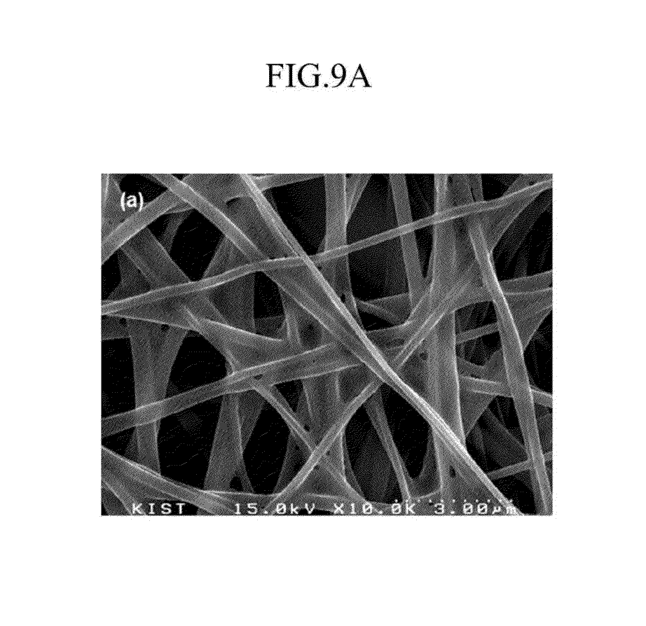

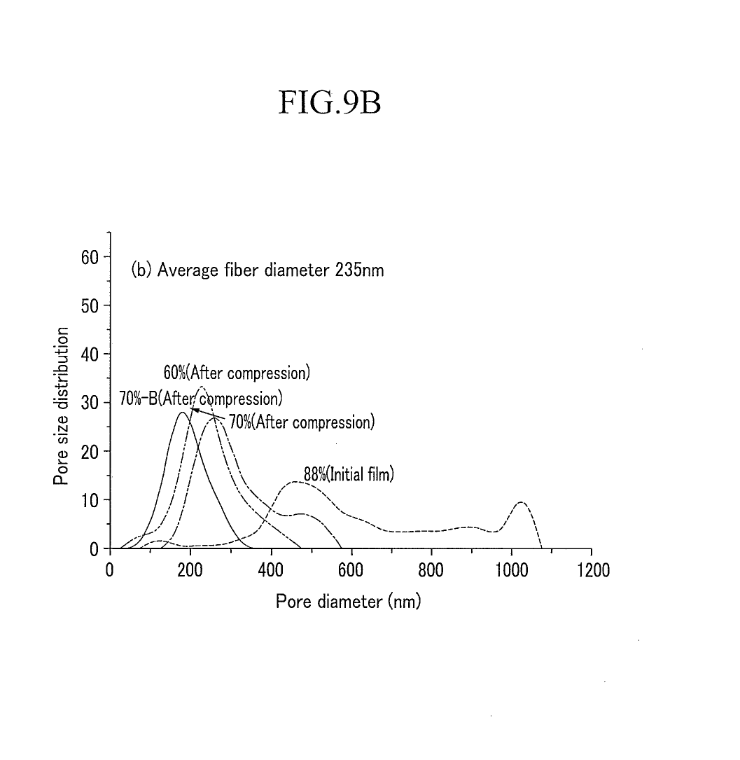

A porous body was prepared in the same manner as in preparation conditions of a porous body having a thickness of about 110 μm, which was composed of a silica/PVdF ultra-fine composite fiber having an average fiber diameter of about 235 nm in Comparative Example 2, but a silica/PVdF ultra-fine composite fiber layer of about 55 μm was first accumulated during the electrospinning process, then a dispersion liquid of the bohemite nanofiber was air-sprayed with an air pressure thereon in the same manner as in Example 2-3, but a bohemite nanonet layer was partially introduced as in FIG. 9a and a silica/PVdF ultra-fine composite fiber layer of about 55 μm was again accumulated thereon. The prepared porous body was subjected to hot pressing at about 130° C. to a porosity level of about 70% to prepare a fiber-based filter. The pore size and distribution of fiber-based filters in which the bohemite nanonet layer was introduced and was not introduced are shown in FIG. 9b. Even though the bohemite nanonet layer was partially introduced, the average pore size and pore size distribution are sharply reduced and large pores disappeared. In particular, a nanonet layer was introduced to greatly reduce the pores having the most frequency from about 286 nm to about 175 nm in a porosity of about 70%. The flux was about 571 L/hr/m², and the filter efficiency of a polystyrene latex dispersion solution of about 105 nm at a concentration of about 100 ppm was 81.2%.

### Example 3-3

### Preparation of M-Aramid/PVdF Ultra-Fine Fiber-Based Filter Having Bohemite Nanonet Layer

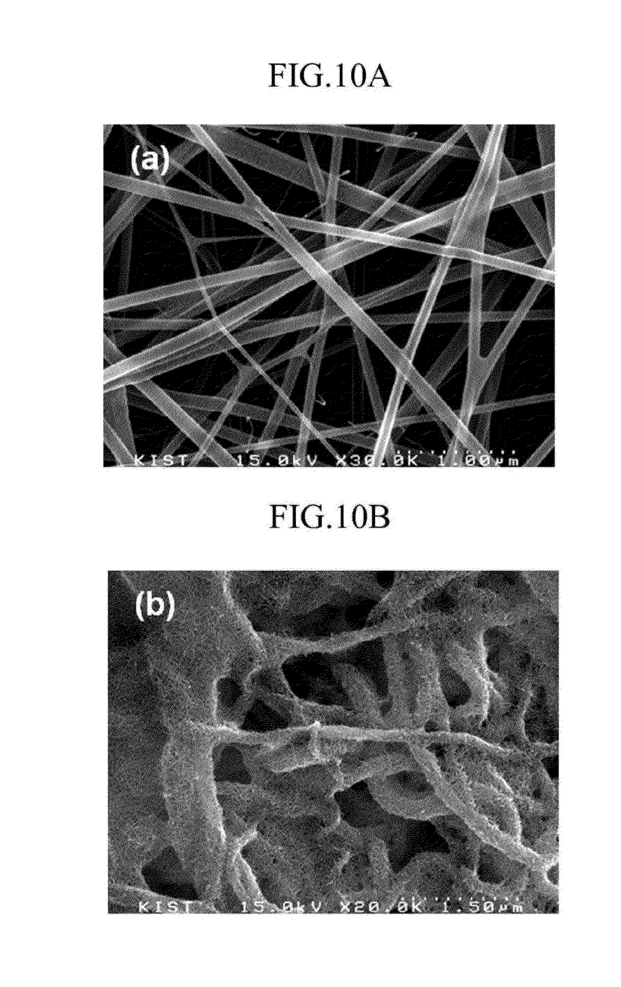

An m-aramid/PVdF solution prepared by dissolving about 79.8 g of an m-aramid (Aldrich Corp.) and about 23.2 g of polyvinylidene fluoride (Kynar 761) in a solvent prepared by dissolving about 30 g of calcium chloride in about 750 g of dimethylacetamide (DMAc) was electrosprayed under a high-voltage electric field of about 20 kV at a discharge rate of about 10 μl/min to prepare an m-aramid/PVdF complex nanofiber having an average fiber diameter of about 145 nm as illustrated in FIG. 10a. During the electrospinning process of preparing a super-micro fiber, first, an m-aramid/PVdF ultra-fine composite fiber layer of about 40 μm, a bohemite nanonet layer by air-spray [FIG. 10b], an m-aramid/PVdF ultrafine composite fiber layer of about 40 μm, and an m-aramid/PVdF ultra-fine composite fiber layer of about 40 μm were continuously stacked to prepare an m-aramid/PVdF ultra-fine composite fiber-based porous body with a thickness of about 120 μm, having a bohemite nanonet layer. The prepared porous body was subjected to hot pressing at about 130° C. to a porosity level of about 70% to prepare a fiber-based filter. The average pore size of the filter was about 87 nm in a porosity of about 70%, and the pores having the most frequency were greatly reduced to about 65 nm. The flux was about 271 Uhr/m², and the filter efficiency of a polystyrene latex dispersion solution of about 105 nm at a concentration of about 100 ppm was 99.9%.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fiber-based filter comprising a filtration layer, comprising:
a fiber-based porous body having a most frequent pore size from about 0.1 μm to about 2 μm in a pore size distribution, wherein a ultra-fine fiber is continuously and randomly disposed, and
a nanonet layer having a most frequent pore size from about 1 nm to about 100 nm in a pore size distribution, wherein an anisotropic nanomaterial is disposed.

2. The fiber-based filter of claim 1, wherein:
the anisotropic nanomaterials are nanorods comprising a metal oxide or carbon, a nanotube, or a mixture thereof.

3. The fiber-based filter of claim 1, wherein:
an average diameter of the anisotropic nanomatreial is from about 1 nm to about 100 nm and a ratio of a fiber length to an average fiber diameter is from about 50 to about 3,000.

4. The fiber-based filter of claim 1, wherein:
the anisotropic nanomaterial comprises a metal oxide including bohemite (AlOOH), aluminum hydroxide (Al(OH)₃), γ-alumina (γ-Al₂O₃), titanium dioxide (TiO₂), or zinc oxide (ZnO), carbon nanofiber, single wall carbon nanotube (SWCNT), double wall carbon nanotube (DWCNT), multi-wall carbon nanotube (MWCNT), carbon nanorod, graphite nanofiber, or a mixture thereof.

5. The fiber-based filter of claim 1, wherein:
the ultra-fine fiber has an average diameter from about 100 nm to about 3,000 nm, and is a polymer ultra-fine fiber, a metal oxide ultra-fine fiber, or a mixed ultra-fine fiber of a polymer and a metal oxide.

6. The fiber-based filter of claim 5, wherein:
the polymer in the ultra-fine fiber is polyacrylonitrile, polyvinylalcohol, polyvinylidene fluoride, cellulose, polyvinylpyrrolidone, polyamideimide, polyetherimide, polyimide, polyamide, polyphenylenesulfone, polyethersulfone, polyetheretherketone, a polymer resin having —SO₃H, COOH or an ionic functional group, a copolymer thereof, or a mixture of two or more polymers.

7. The fiber-based filter of claim 6, wherein:
when the polymer is a mixture of the two or more polymers, one component has a multi-core structure and the other component has a shell structure.

8. The fiber-based filter of claim 5, wherein:
the metal oxide in the ultra-fine fiber is silica, alumina, titanium dioxide, zirconia, or a mixture thereof.

9. The fiber-based filter of claim 8, wherein:
the precursor of the metal oxide is represented by M(OR)x, MRx(OR)y, MXy or M(NO₃)y, where, M is Si, Al, Ti, or Zr, R is a C₁-C₁₀ alkyl group, X is F, Cl, Br, or I, and x and y are an integer of 1 to 4.

10. The fiber-based filter of claim 1, wherein:
wherein the polymer and metal oxide-mixed ultra-fine fiber is a skin multicore-shell nanostructure having a surface layer of a metal oxide component, a shell layer of a polymer component, and a multi core of a metal oxide component, or a multi core-shell nanostructure having a shell layer of a polymer component without a surface layer and a multi core of a metal oxide component.

11. A method for preparing a fiber-based filter, comprising:
electrospinning a polymer solution, a metal oxide precursor sol-gel reaction solution, or a mixed solution of a sol-gel solution of a metal oxide precursor and polymer to prepare a filtration layer comprising a ultra-fine fiber-based porous body, and
spraying an anisotropic nanomaterial dispersion liquid to the ultra-fine fiber-based porous body to form a nanonet layer.

12. The method of claim 11, wherein:
wherein the electrospinning is melt-blowing, flash spinning, or electro-blowing.

13. The method of claim 11, wherein:
the nanonet layer is formed by subjecting a dispersion liquid of an anisotropic nanomaterial to electrospray, air-spray or both of them.

14. The method of claim 11, wherein:
the ultra-fine fiber-based porous body is subjected to hot pressing in a range from a glass transition temperature (T₉) to a melting temperature (Tₘ) of the polymer.

15. The method of claim 11, wherein:
the fiber-based porous body is subjected to heat treatment in a temperature interval from about 150° C. to about 350° C.
